(19) United States
(12) Patent Application Publication
(10) Pub. No.: US 2026/0009228 A1
(43) Pub. Date: Jan. 8, 2026

(54) PEEL AND STICK TEMPORARY ROOFING MEMBRANE

(71) Applicant: CARLISLE CONSTRUCTION MATERIALS, LLC, Carlisle, PA (US)

(72) Inventors: Nathan VAIL, Carlisle, PA (US); Austin Kulp, Carlisle, PA (US)

(73) Assignee: CARLISLE CONSTRUCTION MATERIALS, LLC, Carlisle, PA (US)

(21) Appl. No.: 19/256,909

(22) Filed: Jul. 1, 2025

Related U.S. Application Data
(60) Provisional application No. 63/667,541, filed on Jul. 3, 2024.

(51) Int. Cl. E04D 5/14; B32B 27/08; B32B 37/26; E04D 5/06

(52) U.S. Cl. CPC E04D 5/148; B32B 27/08; E04D 5/06; B32B 2037/268; B32B 2307/71; B32B 2307/7246; B32B 2419/06

(57) ABSTRACT

A peel and stick temporary roofing assembly, including: an air/vapor barrier membrane; top and bottom adhesive layers on the air/vapor barrier membrane; and top and bottom release layers. The peel and stick temporary roofing assembly is incorporated into a permanent roofing assembly by securing an insulation board and a roofing membrane thereover.

### RELATED APPLICATION

The present application claims priority to U.S. Provisional Patent Application Ser. No. 63/667,541, of same title, filed Jul. 3, 2024, the entire disclosure of which is incorporated herein by reference in its entirety for all purposes.

### TECHNICAL FIELD

The present invention relates to temporary roofing structures.

### BACKGROUND OF THE INVENTION

During standard building construction, temporary roofing systems are used. A temporary roof provides cover over the top of the building when other (i.e.: non-roofing) building trades are working inside, or when these trades are working on the roof itself (for example, installing vents and filters in the roof). A temporary roof makes the building waterproof quickly. Only after the other (non-roofing) building trades have completed their work is the final (i.e.: permanent) roof installed. If a permanent roof is initially put down too soon (i.e.: prior to other building trades completing their work), there is a danger of entrapped moisture getting into the insulation. For all of the above reasons, a temporary roof structure is commonly used.

Exiting temporary roofs typically last for about 3 months (before the final finished roof must be installed). Due to the duration of standard building construction, it would instead be desirable to provide temporary roofing solutions that could last 6 to 10 months or 8 to 10 months. Longer lasting temporary roofs would provide more time for building construction to be completed.

Another important problem with temporary roofs is that they must be pulled up and removed before the final roofing structure is put down in its place. It would instead be desirable to decrease the amount of time spent in removing the temporary roof or, if possible, completely avoid having to remove the temporary roof to install the final roofing system.

“Peel and Stick” waterproofing systems also exist. An example is found in Published U.S. Patent Application 2023/0140264, entitled Separation Sheet And Use Therefore For Providing Waterproofed Structures. This system is owned by Sika Technology AG of Baar, Switzerland. It uses a Peel and Stick waterproofing material having adhesives on its top and bottom surfaces with the adhesives covered by release layers. Sika's system is not a temporary roof and is not configured for use as a temporary roof. Instead, it is installed as part of the final permanent roof when the roofing membrane is placed thereover. Specifically, this peel and stick waterproofing layer is placed directly on top of a roofing structure (or on an insulation board on top of the roofing structure). Next, the top roofing membrane is placed over the top of this waterproofing membrane. As such, the adhesive layers on the top and bottom of Sika's waterproofing membrane are used to secure the final roofing membrane onto the roof as the permanent roof structure is built.

What is instead desired is a waterproof temporary roof that is specifically designed to last for several months. Ideally, such a temporary roof would not need to be removed. Instead, what is desired is a temporary roof that can be incorporated directly into the final roof design. As will be shown, the present invention provides such a system.

### SUMMARY OF THE INVENTION

The present invention provides a double sided peel and stick air/vapor barrier that is ideally suited for use as a temporary roofing membrane. In addition, the present system need not be removed when the final permanent roof is installed. Instead, the present temporary roof system is designed to be incorporated directly into the final permanent roof design.

One advantage of the present system is that it provides a temporary roofing solution that can last much longer than current temporary roofing solutions. Current temporary roofs typically last about three months. In contrast, the present peel and stick temporary roofing membrane may preferably last six to ten or, more preferably, eight to ten months. As such, the present peel and stick temporary roofing membrane offers the advantage of enduring a full weather cycle. This can be achieved in part due to the present system's use of a UV stable material in the top release layer. Specifically, this UV stable material protects the air/vapor membrane from degradation during its stage of use as a temporary roof.

UV protection may be obtained by the addition of one or more antioxidants, UV absorber and light stabilizer additives, and light effective pigments to the layer. By way of example only, antioxidants may include hindered phenols, thiosynergists, hydroxylamines, phosphates, and alpha-tocopherol. Commercially available antioxidants include Irganox® and Irgafos® from BASF; Anox®, Lowinox® and Weston® from Addivant; Songnox® from Songwon; Evernox® and Everfos® from Everspring; BNX® from Mayzo; Thanox® from Rianlon. In addition, or as an alternative, UV protection may be achieved by addition of UV absorbers and light stabilizers, which may include, for example, benzotriazole, hydroxybenzoate, benzophenone, triazine, and hindered amines of various molecular weights. These additives are commercially available from BASF under the brand names Tinuvin® and Chimassorb® and from Solvay under the brand name Cyasorb®, from Sabo under the brand name SaboSTAB®, from Songwon under the brand name of Songsorb®, from Mayzo under the brand name of BLS®, from Everspring under the brand name of EverSTAB®, from Rianlon under the brand of Thasorb®, and from Addivant under the brand of Lowilite. In addition, light reflective pigments can be used to screen UV light, which may include, for example, titanium dioxide. These pigments are commercially available as Ti-Pure® from Chemours, as Kronos® TiO2 from Kronos, as Tiona® from Cristal, as Troxide® from Huntsman, and as Tronox® TiO2 from Tronox. It is to be understood, however, that the present system is not limited to these particular exemplary materials for providing UV protection.

This UV stable top release layer is only removed when it comes time to secure the final roofing membrane, or final insulation board and final roofing membrane thereover. At that time, the air/vapor membrane is covered and sunlight does not reach it.

As stated above, an important advantage of the present peel and stick air/vapor barrier is that it can first be used as a temporary roofing membrane and then later be incorporated straight into the final roof (without being removed). Simply put, it does not need to be removed when the final roofing is installed. This saves both time and money.

The present system proves a double-sided peel and stick air/vapor barrier that is ideally suited (but not limited to) low slope roofing applications.

In one embodiment, the present invention provides a peel and stick temporary roofing membrane assembly, comprising:
an air/vapor barrier membrane;
an top adhesive layer on top of the air/vapor barrier membrane;
a top release layer on the top adhesive layer;
a bottom adhesive layer underneath the air/vapor barrier membrane; and
a bottom release layer underneath the bottom adhesive layer.

Preferably, the air/vapor barrier membrane is made of EPDM. In optional embodiments, the top of the air/vapor barrier membrane is darker than the bottom of the air/vapor barrier membrane. This has the advantage of having the darker top dry faster.

In optional embodiments, each of the top and bottom release layers may be split into sections side-by-side one another for ease of removal. In addition, the edges of the side-by-side sections may overlap one another to assist in removing these sections quickly by hand. Pull tabs may be attached to these individual sections to make removal quick and easy.

As stated above, the top release layer preferably comprises a UV stable material. This has the advantage of increasing the expected lifetime of the temporary roof. Simply put, the UV stable material in the top release layer prevents damaging sun exposure to the air/vapor barrier membrane during its few months as a temporary roof.

The present invention also encompasses the method of installing a roofing system by incorporating a temporary roofing membrane into a final roofing system, by:
(a) installing a peel and stick roofing membrane assembly onto a roof, wherein the peel and stick roofing membrane assembly comprises:
   an air/vapor barrier membrane;
   an top adhesive layer on top of the air/vapor barrier membrane;
   a top release layer on the top adhesive layer;
   a bottom adhesive layer underneath the air/vapor barrier membrane; and
   a bottom release layer underneath the bottom adhesive layer; and then
(b) installing an insulation board on top of the peel and stick roofing membrane assembly; and then
(c) covering the insulation board with a final roofing membrane.

In preferred aspects, the peel and stick roofing membrane assembly may be installed by simply removing the bottom release layer and then adhering the bottom adhesive layer directly onto the roof.

In preferred aspects, an insulation board may be installed by removing the top release layer and then placing the insulation board onto the top adhesive layer of the peel and stick roofing membrane assembly. The final roofing membrane is then installed on top of this insulation board.

In preferred aspects, the step of installing the insulation board on top of the peel and stick roofing membrane assembly is performed 6 to 10 or more preferably 8 to 10 months after the step of installing the peel and stick roofing membrane assembly onto a roof. As such, the present temporary roofing system can last a full weather cycle before the final roofing membrane is installed thereover.

### BRIEF DESCRIPTION OF THE DRAWINGS

FIG. 1 is a sectional elevation view of the present temporary roof structure.

FIG. 2 is a perspective view of the present temporary roof structure incorporated into a final roofing structure.

FIG. 2A is a close-up view of one side of FIG. 2.

FIG. 2B is a close-up view of the other side of FIG. 2.

### DETAILED DESCRIPTION OF THE DRAWINGS

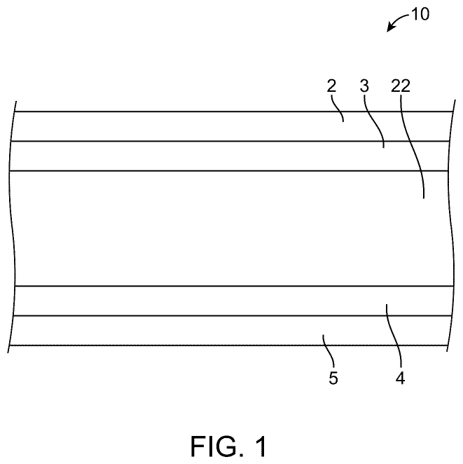

Referring first to FIG. 1, the present system provides a peel and stick temporary roofing membrane assembly 10, comprising:
an air/vapor barrier membrane 22;
an top adhesive layer 3 on top of the air/vapor barrier membrane 22;
a top release layer 2 on the top adhesive layer 23;
a bottom adhesive layer 4 underneath the air/vapor barrier membrane 22; and
a bottom release layer 5 underneath the bottom adhesive layer 4.

In preferred embodiments, the air/vapor barrier membrane 22 is made of EPDM. It is to be understood that it may also be made out of other suitable materials such as TPO, Polyethylene (PE) sheeting, Bituminous materials, or non-Bituminous sheets or other suitable materials.

In preferred embodiments, the top surface of the air/vapor barrier membrane 22 may be darker than the bottom of the air/vapor barrier membrane to speed drying.

In other optional aspects, each of the top and bottom release layers 2 and 5 may be made in sections that are side-by-side one another. By having the release membrane sections narrower than the air/vapor barrier membrane itself, side-by-side sections of release layers 2 and 5 are easier for an operator to handle and pull off when installing air/vapor membrane 22 onto a roof as the temporary roof. Optionally, the side-by-side release layer sections overlap one another to make them easier for an installer to pull off. Optionally as well, pull tabs extending from the release layers or release layer sections may also be used.

In preferred aspects, top release layer 3 comprises a UV stable material. The advantage of having a UV stable material in top release layer 3 is that it extends the life of the temporary roofing system (since top release layer 3 will protect air/vapor barrier membrane 22 during the period of time in which air/vapor barrier membrane 22 is working as the temporary roof before an insulation board and final roofing membrane are installed thereover). UV protection may be obtained by the addition of one or more antioxidants, UV absorber and light stabilizer additives, and light effective pigments to the release layer. By way of example only, antioxidants may include hindered phenols, thiosynergists, hydroxylamines, phosphates, and alpha-tocopherol. Commercially available antioxidants include Irganox® and Irgafos® from BASF; Anox®, Lowinox® and Weston® from Addivant; Songnox® from Songwon; Evernox® and Everfos® from Everspring; BNX® from Mayzo; Thanox® from Rianlon. In addition, or as an alternative, UV protection may be achieved by addition of UV absorbers and light stabilizers, which may include, for example, benzotriazole, hydroxybenzoate, benzophenone, triazine, and hindered amines of various molecular weights. These additives are commercially available from BASF under the brand names Tinuvin® and Chimassorb® and from Solvay under the brand name Cyasorb®, from Sabo under the brand name SaboSTAB®, from Songwon under the brand name of Songsorb®, from Mayzo under the brand name of BLS®, from Everspring under the brand name of EverSTAB®, from Rianlon under the brand ofThasorb®, and from Addivant under the brand of Lowilite. In addition, light reflective pigments can be used to screen UV light, which may include, for example, titanium dioxide. These pigments are commercially available as Ti-Pure® from Chemours, as Kronos© TiO2 from Kronos, as Tiona® from Cristal, as Troxide® from Huntsman, and as Tronox® TiO2 from Tronox.

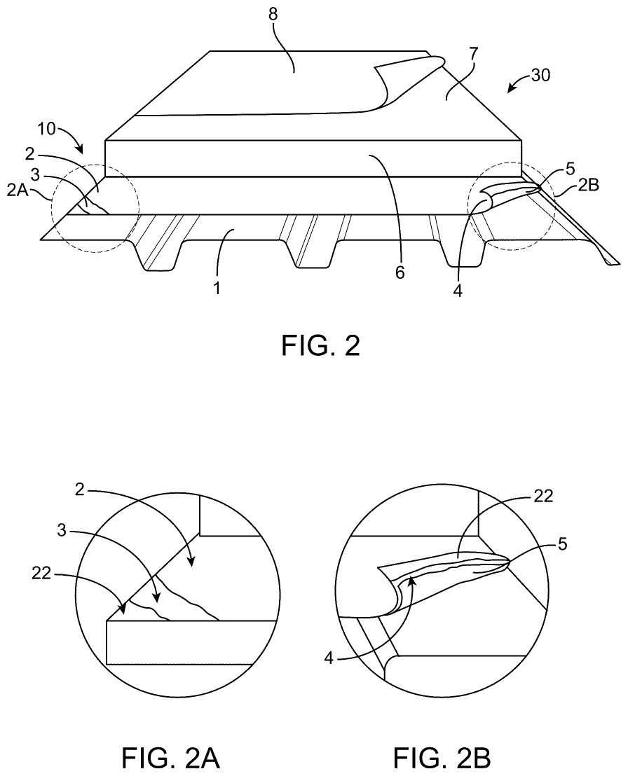

Referring next to FIGS. 2, 2A and 2B, the present system provides a method of installing a roofing system by incorporating a temporary roofing membrane 10 into a final roofing system 30, comprising:
(a) installing a peel and stick roofing membrane assembly 10 onto a roof, wherein the peel and stick roofing membrane assembly comprises:
   an air/vapor barrier membrane 22;
   an top adhesive layer 3 on top of the air/vapor barrier membrane 22;
   a top release layer 2 on the top adhesive layer 3;
   a bottom adhesive layer 4 underneath the air/vapor barrier membrane 22; and
   a bottom release layer 5 underneath the bottom adhesive layer 24; and then
(b) installing an insulation board 6 on top of the peel and stick roofing membrane assembly 10; and then
(c) covering the insulation board with a final roofing membrane 8 (preferably using an adhesive layer 7 between permanent roofing membrane 8 and insulation board 6).

In preferred aspects, the peel and stick roofing membrane assembly 10 is installed by removing bottom release layer 5, and then adhering the bottom adhesive layer 4 onto the roof 1.

When the final permanent roof is installed, the insulation board 6 is installed by removing the top release layer 2 and then placing the insulation board 6 onto the top adhesive layer 3 of the peel and stick roofing membrane assembly 10.

As can be seen, the present system provides a temporary roof that does not need to be removed when the final roofing is installed. Instead, the temporary roofing structure is simply directly incorporated into the final, permanent roofing assembly. As such, the temporary roof becomes part of the final, permanent roof. This saves time and money. In preferred aspects, the step of installing the insulation board 6 on top of the peel and stick roofing membrane assembly 10 is performed 6 to 10 months or more preferably 8 to 10 months after the step of installing the peel and stick roofing membrane assembly 10 onto the metal deck 1 of the roof. As a result, the step of installing the insulation board 6 on top of the peel and stick roofing membrane assembly 10 is performed a full weather cycle after the step of installing the peel and stick roofing membrane assembly 10 onto a roof 1.

The step of covering the insulation board 6 with the final roofing membrane 8 preferably comprises placing an adhesive 7 over the top of the insulation board 6 and then covering the adhesive 7 with a TPO or EPDM (Polyethylene (PE) sheeting, Bituminous materials, or non-Bituminous sheets) membrane 8.

In preferred aspects, the present system may be used with a Fleeceback™ type of roofing membrane 8. Specifically, adhesive layer 7 may be used to attach the Fleeceback™ membrane 8 to the top of insulation board 6. It is to be understood, however, that the present invention also encompasses embodiments that do not have or use an insulation board 6. In such embodiments, the adhesive layer 3 may be used to hold the Fleeceback™ roofing membrane 8. Alternatively, if the adhesive layer 3 is not a desired adhesive, then heat (such as a torch) can be used to both remove the top release layer 2 and its underlying adhesive layer 3. Once adhesive layer 3 has been removed, a different adhesive material can be used to secure the Fleeceback™ roofing membrane 8, as desired.

In preferred embodiments, the preferred thickness of air/vapor barrier membrane 22 is from 4 mils (0.01 mm) to 40 mils (1 mm). In preferred aspects, adhesive layers 3 and 4 may be made of a Rubber-based Pressure Sensitive Adhesive (PSA) (butyl or SBR), an Acrylic PSA, a Hot-melt PSA, a Block-copolymer PSA, a SBS-modified bitumen, butyl rubber adhesive taps, or a Double-sided acrylic PSA. Other adhesives can also be used, all keeping within the scope of the present invention.

assembly by securing an insulation board and a roofing membrane thereover.

What is claimed is:

1. A peel and stick temporary roofing membrane assembly, comprising:
an air/vapor barrier membrane;
an top adhesive layer on top of the air/vapor barrier membrane;
a top release layer on the top adhesive layer;
a bottom adhesive layer underneath the air/vapor barrier membrane; and
a bottom release layer underneath the bottom adhesive layer.

2. The assembly of claim 1, wherein the air/vapor barrier membrane is made of EPDM, TPO Polyethylene (PE) sheeting, Bituminous materials, or non-Bituminous sheets.

3. The assembly of claim 1, wherein the top of the air/vapor barrier membrane is darker than the bottom of the air/vapor barrier membrane.

4. The assembly of claim 1, wherein each of the top and bottom release layers are split into sections side-by-side one another.

5. The assembly of claim 4, wherein edges of the side-by-side sections overlap one another.

6. The assembly of claim 1, wherein the top release layer comprises a UV stable material.

7. A roofing assembly, comprising:
a peel and stick temporary roofing membrane assembly, comprising:
an air/vapor barrier membrane;
an top adhesive layer on top of the air/vapor barrier membrane;
a top release layer on the top adhesive layer;
a bottom adhesive layer underneath the air/vapor barrier membrane, and
a bottom release layer underneath the bottom adhesive layer;
an insulation board secured to the top adhesive layer after the top release layer has been removed; and
a roofing membrane secured on top of the insulation board.

8. The roofing assembly of claim 7, wherein the top release layer comprises a UV stable material.

9. The roofing assembly of claim 7, wherein the UV stable material is an antioxidant, UV a absorber, a light stabilizer additive, or a light effective pigment.

10. A method of installing a roofing assembly by incorporating a temporary roofing membrane into a permanent roofing system, comprising:
installing a peel and stick temporary roofing assembly onto a roof, wherein the peel and stick temporary roofing assembly comprises:
an air/vapor barrier membrane;
an top adhesive layer on top of the air/vapor barrier membrane;
a top release layer on the top adhesive layer;
a bottom adhesive layer underneath the air/vapor barrier membrane; and
a bottom release layer underneath the bottom adhesive layer; and then
installing an insulation board on top of the peel and stick roofing membrane assembly; and then
covering the insulation board with a final roofing membrane.

11. The method of claim 10, wherein the peel and stick roofing temporary roofing assembly is installed by:
removing the bottom release layer, and then
adhering the bottom adhesive layer onto the roof.

12. The method of claim 10, wherein the insulation board is installed by:
removing the top release layer, and then
placing the insulation board onto the top adhesive layer of the peel and stick roofing membrane assembly.

13. The method of claim 10, wherein the step of installing the insulation board on top of the peel and stick temporary roofing assembly is performed 6 to 10 months after the step of installing the peel and stick temporary roofing assembly onto a roof.

14. The method of claim 10, wherein the step of installing the insulation board on top of the peel and stick temporary roofing assembly is performed a full weather cycle after the step of installing the peel and stick temporary roofing assembly onto a roof.

15. The method of claim 10, wherein the step of covering the insulation board with the final roofing membrane comprises placing an adhesive over the top of the insulation board and then covering the adhesive with a TPO or EPDM membrane.

16. The method of claim 10, wherein each of the top and bottom release layers are split into sections side-by-side one another, and the steps of removing each of the top and bottom release layers is performed by removing the side-by-side sections one after another.
